(19) United States
(12) Patent Application Publication
(10) Pub. No.: US 2009/0218281 A1
(43) Pub. Date: Sep. 3, 2009

(54) Water Treating Method and Arrangement Integrating a Fixed-Bacteria Biological Treatment and Flocculation-Decantation

(75) Inventors: Philippe Sauvignet, Saint-Etienne-En-Cogles (FR); Kashi Banerjee, Moon Township, PA (US); Charles Blumenschein, Pittsburgh, PA (US)

Correspondence Address: COATS & BENNETT, PLLC, 1400 Crescent Green, Suite 300, Cary, NC, 27518, US

(73) Assignee: OTV SA, Saint-Maurice Cedex (FR)

(21) Appl. No.: 12/091,849

(22) PCT Filed: Oct. 23, 2006
(86) PCT No.: PCT/EP2006/067679

§ 371 Date: Jul. 7, 2008

(30) Foreign Application Priority Data
Oct. 28, 2005 (FR) 05 11084
Nov. 17, 2005 (FR) 05 11669

(51) Int. Cl. C02F 3/00; C02F 1/52

(52) U.S. Cl. 210/608; 210/150

(57) ABSTRACT

The inventive water treating method and arrangement successively combine at least one step consisting in biological treating at least one part of pollution contained in said waters by a fixed biomass, wherein a bio-cleaned flow logically obtainable at the and of said step, prior to the entry thereof to a next step, contains less than 2 g/l of SS, and at least one stage for carrying out a flocculation-decantation by ballasted flocs consisting in transferring biologically treated flow to a mixing area (2), preferentially at a velocity gradient ranging from 10 s−1 to 1000 s−1, wherein at least one type of denser than water insoluble granulated material is injected and suspended matters are aggregated around said granulated material particles, in transferring the flow issued from the mixing area (2) to a decantation area, wherein the clarified flow and decantation sludges mixed with the granulated material are separated, in extracting granulated material from the decantation sludges, in recycling major part thereof is in the mixing area (2) and in removing the decantation sludges separated form the granulated material.

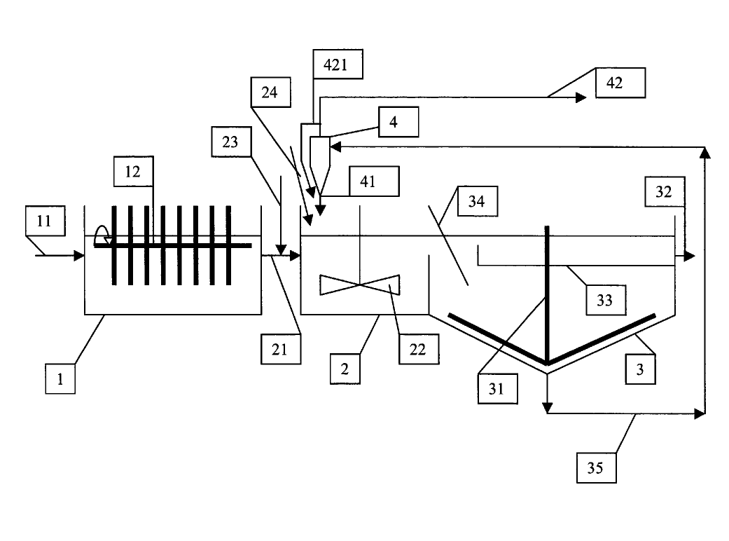

This invention relates to the field of water treatment.

More precisely, the invention relates mainly to a method combining high-speed biological treatment of biologically treated water, using fixed bacteria and clarification with ballasted flocs.

The invention may be used for the treatment of any type of water containing impurities that could be eliminated by a biological treatment with fixed bacteria requiring clarification after biological treatment, particularly such as the following, without prejudice to equivalent use for similar applications:
waste water treated by a bacterial bed in which the treating bacteria are fixed on fixed supports (rollers, plastic or mineral linings) or rotating supports in the water (rotating disks or drums to provide the oxygen necessary for the bacteria) in order to eliminate excess sludge from the biologically treated water;
waste water or water intended for human consumption treated by an MBBR (Moving Bed Biological Reactor), in which the bacteria that are designed to treat pollution, particularly carbonaceous, ammonia or nitrate pollution, are fixed on supports with a small unit size, typically between a few millimetres and a few centimetres, with a density similar to the density of water in order to remove excess sludge from the biologically treated water;
waste water or water intended for human consumption treated by biofiltration on filters lined with large diameter material, are used for continuous cleaning of excess biological and filtration sludge in which the treating bacteria (particularly carbonaceous, ammonia or nitrate pollution) are fixed on a filter support foundation composed of balls, cylinders, pearls or similar supports in order to remove excess sludge from the biologically treated water.

In the current state of the art, water containing excess sludge produced by a biological process with fixed bacteria operating continuously, of the bacterial bed or MBBR type, is usually clarified in a classical secondary clarifier functioning at speeds of the order of one meter per hour (usually from about 0.6 m/h to a maximum of 2 m/h), making it necessary to have large surface areas in order to achieve the clarification work necessary after the biological treatment.

There is a technique in the current state of the art described in French patent application FR2719235 published on Nov. 3, 1995, associating an activated sludge treatment with a clarification treatment by flocculation-settlement with ballasted fine sand floc, in order to clarify water at surface settlement speeds of up to 6 m/h or more.

Due to the use of ballasted floc settlement, this technique that is capable of achieving settlement in surface areas already reduced by a factor of the order of 3 to 10 has the disadvantage that it requires the use of activated sludge as the biological treatment method.

Activated sludge has several types of disadvantages.

Firstly, the activated sludge requires that the entire treating bacterial mass is clarified, in suspension in the water output from the activated sludge pond, and the vast majority of clarification sludge is recirculated so as to maintain the bacterial mass necessary for treatment in the activated sludge ponds, which usually means that settlement at a flow rate of more than about twice the flow rate to be treated is necessary, taking account of a recirculation of sludge usually of the order of the flow to be treated, making it necessary to construct large settlement structures;

Secondly, settlability requirements for activated sludge make it necessary to limit the concentration of activated sludge in the pond to values of the order of 3 to 6 g of Suspended Solids (SS) per litre (even in the case of clarification with ballasted flocs according to patent FR2719235, unless very high and economically unrealistic recirculation rates are provided), which considering the biological mass necessary for the treatment of a given pollution flow, require large pond volumes compared with the volumes necessary when the biomass is fixed;

Finally, large concentrations of dry material in the water to be settled (3 to 6 g SS/l) require the application of large reagent doses (often more than 1 mg/l of flocculation polymer), on approximately doubled flow rates due to the recirculation of sludge, leading to large reagent consumptions.

The main purpose of this invention is to solve these problems by divulging a water treatment process, characterised in that it comprises in sequence at least one fixed biomass biological treatment step of at least part of the pollution contained in said water, the biologically purified flow obtained at the output from this step containing less than 2 g/l of SS before it is input into the next step, and at least one flocculation-settlement step with ballasted flocs in which:

the biologically treated flow is transferred into a mixing zone, preferably at a velocity gradient of between 10 s⁻¹ and 1000 s⁻¹, in which at least one insoluble granular material denser than water is injected and is held in suspension and in which at least part of the suspended solids are left to aggregate around the particles of said granular material,

the flow output from said mixing zone is transferred into a settlement zone in which a clarified effluent is separated from the settlement sludge mixed with granular material,

the granular material is extracted from the settlement sludge, and most of it is recycled in said mixing zone,

the settlement sludge separated from the granular material is extracted.

Compared with the state-of-the-art for activated sludge, the invention enables a compact biological treatment due to large concentrations of biomass possible with fixed biomass processes, while treating only a flow rate approximately equal to the flow rate to be treated (the only difference being any recirculation necessary for periodic washing of the biomass support) in secondary decantation, because there is no need for sludge recirculation, the bacteria necessary for treatment being fixed on their support, which reduces the size of the settlement installations by a first reduction factor.

According to one variant of the invention, at least part of the settlement sludge separated from the granular material can also be recycled to the mixing zone.

The method according to the invention can also be used for treatment at high <<mirror >> speeds (treated flow divided by the settlement area) in secondary decantation, at between 15 m/h and more than 100 m/h.

The method according to the invention can also reduce quantities of flocculent polymer used due to the smaller quantity of SS to be flocculated (only excess biomass needs to be treated, namely concentrations of less than 2 g/l, and usually even less than 1 g/l) and due to the fact that approximately only the raw water flow is treated (because the invention does not use sludge recirculation that doubles the flow rate to be treated).

Preferably, said fixed biomass biological treatment step is chosen among the following biological treatment types: bacterial beds, <<Moving Bed Biological Reactors>> (MBBRs), biofilters, biological disks.

Also preferably, said biomass is fixed to a support chosen from among the following types—balls, rollers, plates, ribbons, pall, raschig or similar type rings, disks or drums, these supports being fixed or mobile, or in suspension in the water to be treated.

Advantageously, the concentration of SS in the biologically treated flow obtained at the output from the first biological treatment step is less than 1 g/l.

Also advantageously, the process according to the invention comprises a step consisting of injecting at least one flocculating reagent into said mixing zone.

Preferably, the process according to the invention also comprises at least one step consisting of injecting at least one coagulating reagent. This coagulating reagent may be injected on the input side of said flocculating reagent, in the mixing zone or on the input side of the mixing zone and/or in any sludge recirculation loop.

This coagulating reagent may be in the form of a metallic salt (for example like iron chloride or aluminium sulphate) or in the form of an organic coagulant (such as polyDADMAC (polydiallyldimethylammonium chloride)).

Such an injection of a mineral coagulating reagent such as ferric chloride reduces the content of treated water to very low final values of residual phosphorus, less than one milligram per litre, without hindering growth of the biomass because the phosphorus is reduced after the biological treatment. Furthermore, part of the sludge can be recirculated on the input side or in the mixing zone in order to improve elimination of phosphorus and to optimise the use of the injected coagulating reagent, or possibly even to reduce its consumption.

Also preferably, the residence time of said biologically treated flow in said mixing zone is between 1 and 10 minutes and is preferably less than 3 minutes.

This invention also relates to a biological treatment installation for waste water specially designed for implementation of the process described above and characterised in that it includes:
a fixed biomass biological treatment zone comprising at least one biological treatment reactor,
a mixing zone provided with at least one biologically treated main flow arrival channel, obtained at the output from said biological treatment zone, at least one secondary arrival channel connected to a source of granular material insoluble in water and denser than water, and at least one stirring system;
a settlement zone receiving the flow originating from said mixing zone and provided with a clarified effluent extraction channel and an extraction channel for the mix of settled sludge and granular material,
a granular material recuperation zone communicating at the inlet with said extraction channel for the mix of settled sludge and granular material, and communicating at the outlet with said secondary granular material inlet channel and with an excess sludge extraction channel.

Preferably, said biological treatment zone is of the bacterial bed, MBBR or biofilter type.

Also according to one variant of the invention, the installation comprises means of recycling at least part of the sludge separated from the granular material, towards the mixing zone.

Also preferably, said biological treatment zone comprises biomass supports chosen from among balls, rollers, plates, ribbons, pall, raschig or similar type rings, disks or drums.

Advantageously, said mixing zone comprises at least one tank in which at least one steering means is located capable of keeping the granular material in suspension.

Also advantageously, the installation according to this invention comprises means of injection of at least one flocculating agent such as an ionic or cationic polymer, into said mixing zone or in said main inlet channel for said biologically treated flow.

Preferably, said installation comprises means of injection of at least one coagulating agent such as a metallic salt or an organic coagulant, provided on the input side of said means of injection of said flocculating agent.

Also preferably, said granular material is sand with dimensions between 40 micrometers and 300 micrometers.

According to one variant embodiment of the invention, said settlement zone does not have any lamella.

According to another variant, said settlement zone does have lamella.

The invention and the various advantages of it will be more easily understood after reading the following description of a non-limitative embodiment of the invention given with reference to the single FIGURE that diagrammatically shows an installation combining a biological treatment step by RBC (Rotating Biological Contactors) with ballasted settlement flocculation.

With reference to this FIGURE, the water to be treated enters this installation through an inlet 11 to a tank delimiting a biological treatment zone 1 with fixed cultures.

This tank is shown in the FIGURE equipped with rotating biological contactors made by vertical disks mounted on a common horizontal axis 12 in rotation, acting as a support for the treatment biomass.

However, note that any other method of supporting the biomass known to those skilled in the art could be used without departing from the scope of this invention.

The air necessary for biological treatment is brought into contact with the biomass by rotation of the support disks.

The biologically treated flow in this tank that then only contains the excess biomass from the treatment is less than 1 g/l of suspended solids, passes through a passage 21 in a tank delimiting a mixing zone 2.

Within the framework of this embodiment, this passage 21 that forms a main biologically treated inlet flow is reduced to a single opening in a common wall separating the tank delimiting the biological treatment zone 1 from the tank delimiting the mixing zone 2.

This tank delimiting the mixing zone 2 is also provided with a stirrer 22 and a secondary inlet channel of a granular material composed of sand composed of the underflow 41 from a hydrocyclone 4.

Finally, this tank is provided with means 24 of injection of a flocculating reagent and means 23 of injecting a coagulating reagent, that can for example be an iron or aluminium salt, or it can be an organic coagulant such as polyDADMAC, provided on the input side of the injection of the flocculating reagent.

Note that depending on this type (preferably ferric chloride) and its dose, the coagulating reagent can eliminate phosphates remaining in the biologically treated water.

The treated water containing ballasted sand flocs in suspension, is then directed through the baffle 34 to a settlement zone 3. The settled mix of sludge and sand is picked up at this point by a scraper 31 and is pumped through an extraction channel 35 to the hydrocyclone 4. This hydrocyclone 4 forms a zone for recuperation of the granular material (sand), the inlet of which communicates with the extraction channel 35 and the outlet of which is composed of the underflow 41 forming the secondary granular material channel.

All sand is recovered in underflow 41 from the hydrocyclone 4 and is recycled with or without part of the sludge to the mixing zone 2 while the majority of the hydrocycloned sludge is extracted through circuit 42 to a sludge treatment or storage area (not shown). At least some of the sludge separated from the granular material could be recycled into the mixing zone 2 through means 421.

The clarified water is taken out of the settlement zone 3 on the surface through an extraction channel 32 including chutes 33.

The installation described has been used to treat town water. The sand used has an effective diameter of 130 micrometers and a real density of 2.65. Ferric chloride was used as the coagulant, with a content of 50 mg FeCl₃/l. The flocculent used was an anionic flocculent with a content of 1.5 mg/l. A sand/sludge mix recirculation rate equal to 8% was sent to the hydrocyclone with a sand recirculation content equal to 5 kg/m³ of effluent output from the biological treatment zone 1.

A mirror settlement velocity in the settlement zone equal to 30 m/h was implemented concomitantly.

The flow obtained at the outlet from the tank delimiting the biological treatment zone 1 obtained contained less than 600 mg of SS/l. This installation was used to obtain treated water with less than 20 mg of SS/l.

There was a very small sand loss of less than 3 grams of sand per cubic meter of water treated.

The embodiment of the invention described herein is not in anyway intended to reduce its scope.

1-18. (canceled)

19. A method of treating wastewater having suspended solids, the method comprising:
directing wastewater into a fixed-biomass biological reactor;
biologically treating the wastewater in the fixed-biomass biological reactor; and
directing the biologically treated wastewater effluent from the fixed-biomass biological reactor to a ballasted flocculation system at a velocity gradient of approximately 10 s⁻¹ to approximately 1000 s⁻¹.

20. The method of claim 19 wherein the wastewater effluent directed from the fixed-biomass biological reactor into the ballasted flocculation system has a concentration of suspended solids of less than 2 g/l.

21. The method of claim 20 wherein the wastewater effluent directed from the fixed-biomass biological reactor into the ballasted flocculation system has a concentration of suspended solids of less than 1 g/l.

22. The method of claim 19 further comprising biologically treating the wastewater with at least one bacterial bed, moving bed biological reactor, biofilter or biological disk.

23. The method of claim 19 further comprising supporting a fixed biomass in the fixed-biomass biological reactor with at least one ball, roller, plate, ribbon, pall, raschig, disk or drum.

24. The method of claim 19 further comprising mixing the biologically treated wastewater effluent in the ballasted flocculation system for approximately 1 to approximately 10 minutes.

25. The method of claim 24 further comprising mixing the biologically treated wastewater effluent in the ballasted flocculation system for approximately 3 minutes.

26. A system for treating wastewater having suspended solids comprising:
a biological reactor having at least one support for supporting at least one fixed biomass;
a ballasted flocculation system disposed downstream from the biological reactor for receiving wastewater effluent treated in the biological reactor and operative to further treat the wastewater effluent; and
wherein the biological reactor and the ballasted flocculation system are interfaced such that the wastewater effluent is transferred from the biological treatment reactor to the ballasted flocculation system at a velocity gradient of approximately 10 s⁻¹ to approximately 1000 s⁻¹.
